(19) United States
(12) Patent Application Publication
(10) Pub. No.: US 2024/0304343 A1
(43) Pub. Date: Sep. 12, 2024

(54) ENCAPSULATED PEBBLE

(71) Applicant: UNITED KINGDOM ATOMIC ENERGY AUTHORITY, Oxfordshire (GB)

(72) Inventors: Francisco Jose Calvo PLAZA, Madrid (ES); Jorge Fradera FERNANDEZ, Barcelona (ES); Sergio Sadaba CIPRIAIN, Madrid (ES); Samuel HA, Oxfordshire (GB)

(21) Appl. No.: 18/254,672

(22) PCT Filed: Nov. 25, 2021
(86) PCT No.: PCT/EP2021/083042

§ 371 Date: May 26, 2023

(30) Foreign Application Priority Data
Nov. 26, 2020 (EP) 20383029.4

(51) Int. Cl. G21B 1/13; G21C 3/07; G21C 3/08; G21C 3/60; G21C 21/02

(52) U.S. Cl. CPC G21B 1/13; G21C 3/07; G21C 3/08; G21C 3/60; G21C 21/02

(57) ABSTRACT

There is provided an encapsulated pebble, comprising: a fuel core; and a cage encapsulating the fuel core, wherein the cage comprises at least one gas transport channel therethrough. There is also provided a method of making the encapsulated pebble, a breeding blanket module for a fusion reactor, a fusion reactor and methods and uses thereof.

### FIELD OF THE INVENTION

The disclosure relates to an encapsulated pebble, a method of making the pebble, a breeding blanket module, a fusion reactor comprising the pebble and/or the breeding blanket, and uses thereof.

### BACKGROUND OF THE INVENTION

Fuel pebbles are known in nuclear fusion processes as well as nuclear fission processes. In fission processes, pebbles typically comprise impermeable pyrolytic carbon shells, each containing a high number of fuel particles such as TRISO particles.

Pebble beds have also been proposed for fusion reactors, specifically as part of the breeding blanket. In a fusion reactor, the breeding blanket wraps around the reactor core where the plasma is generated, and provides shielding from the neutrons generated in the plasma by absorbing the neutrons, extracts heat for power generation and breeds tritium, necessary for achieving the self-sufficiency principle of a fusion reactor.

Existing blankets can be divided into two categories: liquid (molten fuel) blankets and solid fuel blankets. Liquid blankets have thermal-hydraulic and material compatibility problems due to corrosion at high temperatures, while solid blankets have problems with, for example, tritium extraction.

### SUMMARY OF THE INVENTION

As noted above, there are limitations with existing blankets for fusion processes. It would thus be valuable to have an improvement aimed at addressing these limitations.

Therefore, according to a first aspect, there is provided an encapsulated pebble, comprising:
a fuel core; and
a cage encapsulating the core, wherein the cage comprises at least one gas transport channel therethrough.

The cage encapsulating the core provides structural support and protects the core from impact while still allowing gas to leave the pebble.

According to a second aspect, there is provided a method of forming an encapsulated pebble, comprising:
encapsulating a core within a cage, wherein the cage comprises at least one gas transport channel therethrough.

According to a third aspect, there is provided a breeding blanket module for a fusion reactor, comprising:
a plurality of pebble beds connected in series and/or in parallel; and
a plurality of encapsulated pebbles within each pebble bed.

By connecting the plurality of pebble beds in series and/or in parallel, more efficient cooling and tritium extraction processes can be achieved.

According to a fourth aspect, there is provided a method of operating the breeding blanket module of the third aspect, comprising:
providing a flow of coolant gas to the breeding blanket module:
allowing the coolant gas to extract heat and tritium from the breed blanket module providing a warmed gas enriched with tritium;
removing the warmed gas from the breeding blanket module; and
extracting the tritium from the warmed gas.

According to a fifth aspect, there is provided a fusion reactor comprising at least one encapsulated pebble in accordance with the first aspect, and/or at least one breeding blanket module according to the third aspect.

Uses of the encapsulated pebble of the first aspect and the breeding blanket module of the third aspect constitute further aspects of the disclosure.

According to the aspects described above, the limitations of existing techniques are addressed. In particular, the functions of cooling, structural support and containment are separated out into the different components of the encapsulated pebble. The breeding blanket module also has a low mass of structural material. There is thus provided an improved encapsulated pebble, breeding blanket and uses thereof.

These and other aspects will be apparent from and elucidated with reference to the embodiment(s) described hereinafter.

### BRIEF DESCRIPTION OF THE DRAWINGS

Exemplary embodiments will now be described, by way of example only, with reference to the following drawings, in which:

FIG. 1A depicts an encapsulated pebble according to an embodiment:

FIG. 1B depicts an encapsulated pebble according to an embodiment:

FIG. 2 depicts encapsulated pebbles packed together in a pebble bed according to an embodiment; and

FIG. 3 depicts a breeding blanket module according to an embodiment.

### DETAILED DESCRIPTION OF EMBODIMENTS

### Encapsulated Pebble

As noted above, there is provided herein an encapsulated pebble comprising a core and a cage encapsulating the core. In some embodiments, the encapsulated pebble may be a fuel pebble, suitable for use in a fission reactor. In some embodiments, the encapsulated pebble may be a breeder pebble, suitable for use in a breeding blanket of a fusion reactor. It will be understood that the terms breeder pebble and fuel pebble may be used interchangeably herein when components similar to both systems are being described.

The cage comprises at least one gas transport channel therethrough, to allow gas to leave the core and prevent an excessive build up of pressure within the core. While the present disclosure is concerned primarily with encapsulated pebbles for use in breeding blankets of nuclear fusion reactors, it is seen that the pebbles may also find use in fission processes, for example in molten salt reactors in which gaseous and volatile fission products such as xenon, krypton and iodine are produced and must be captured and disposed of. As used herein, the term “cage” is to be understood as being a three-dimensional structure in which one or more materials, for example a core and/or a ceramic shell are contained. The cage is structurally resilient enough to not deform in use, thereby protecting its contents from being damaged through impact with other objects.

The encapsulated pebble comprises a fuel core. In some examples, the fuel core may also be referred to herein as a breeding core. In fusion processes, the breeding material generates tritium which is the fuel for the fusion process and so is also referred to herein as a fuel-generating core or fuel core. In some examples, the fuel core comprises a breeding material capable of generating tritium, such as those known in existing fusion processes. Operating temperatures for breeding blankets for fusion processes are typically above 300° C. and so the fuel core may comprise a molten salt that is liquid above about 300° C. There are many different molten salts that can be used in breeding blankets. Typically, the breeding material comprises a lithium salt, for example Li₂·BeF₄(FLiBe), as tritium production in fusion reactors is usually achieved by means of the Li⁶(n,α)H³ and Li⁷(n,n′,α)H³ reactions. FLiBe is known to have a high tritium breeding rate (TBR) and has a melting point of 459° C., though other liquid breeders such as PbLi alloys, for example Pb₁₇Li₈₃, or LiF—LiI—LiCl salts are also suitable. It will be understood that the composition of the breeding material, for example a LiF—LiI—LiCl mixture can be tailored to operating requirements.

In some embodiments, the fuel core further comprises a redox controlling material, for example metallic beryllium. In embodiments in which the fuel core comprises a fluoride salt, a redox reaction between generated tritium and fluoride can result in tritium fluoride. Tritium fluoride is as corrosive as hydrogen fluoride and could corrode components of the breeding blanket, including the cage if formed of metal. However, inclusion of a redox controlling material such as metallic beryllium can prevent generation of tritium fluoride so that diatomic (molecular) tritium is formed instead. Other redox controllers such as zirconium could also be used.

The encapsulated pebble comprises a cage encapsulating the fuel core. The cage provides sufficient structural support or rigidity around the fuel core in use and, when present, the ceramic shell, to prevent contact among pebbles to prevent dust generation, withstand the weight of the packed bed and allow deformations due to mechanical loads without impacting on tritium extraction or cooling of the pebbles. In some embodiments, the cage may be spherical or cylindrical. Spherical pebbles are particularly suited to packing into a pebble bed, such as a cylindrical fuel bed as described herein.

The cage comprises at least one gas transport channel therethrough, to allow permeation of tritium and helium from the core through the cage. In this way, efficiency of tritium extraction can be improved, while containing the molten salt in situ and preventing buildup of gas within the pebble. In some embodiments, the cage comprises a plurality of gas transport channels, thus increasing the efficiency of tritium extraction. The gas transport channel may be machined channel, for example produced by laser drilling of the cage to provide holes of about 0.5 μm. In other embodiments, the gas transport channel may be formed by inclusion of pores within the cage. In other embodiments, the cage comprises a wire-like structure, for example comprising a mesh of woven or non-woven fibers. In some examples, the fibers forming the woven or non-woven mesh may be less than 5 mm in diameter, for example less than 3 mm in diameter, for example about 1 mm in diameter. In some examples the mesh may be formed from single stranded fibers, or multi-stranded braided fibers.

In some embodiments, the cage diameter is less than 20 mm, for example less than 15 mm, for example about 10 mm or less. In some embodiments, the cage has a thickness of less than 2 mm, for example less than 1.5 mm, for example about 1 mm or less. In some embodiments, the internal diameter of the cage may be larger than the external diameter of the fuel core. In embodiments in which the encapsulated pebble comprises a ceramic shell surrounding the fuel core, the internal diameter of the cage may be larger than the external diameter of the ceramic shell. Thus, a gap may be provided between the cage and the internal components. By providing a gap between the fuel core and the cage, or between the ceramic shell and the cage, extracted tritium can efficiently permeate from the fuel core and out of the pebble to the pebble bed.

The maximum thermal efficiency of the breeding blanket is determined by the maximum operational temperature of the structural materials. Therefore, the selection of structural materials such as the cage is driven in part by its activation and its performance at high temperatures. Most benefit can be obtained by working in the creep regime, avoiding excessive cyclic thermal stress. Undesirable cyclic loads lead to creep-fatigue interactions and progressive deformation. If the material temperature is reduced too much, then embrittlement radiation effects become dominant. In some embodiments, the cage comprises a metallic cage, for example formed from metallic alloy, for example a steel. The metallic alloy may comprise a reduced activation ferritic martensitic steel, or an austenitic steel or an oxide dispersed steel. Steels used in the nuclear industry are well known. In one embodiment, the cage comprises or is formed from EUROFER 97, a reduced activation ferritic martensitic steel. Other suitable materials include the known steels MHT-9, ODS, F82H and ORNL 9Cr-2WVTa. In other embodiments, the cage comprises a fibrous material, for example carbon fiber or glass fiber. In some embodiments the fibrous material has a gas transport channel by virtue of being a porous fibrous material, for example a woven or non-woven mesh. In some embodiments, the cage comprises a structural ceramic such as silica, or a carbon-fiber composite.

In some embodiments, the encapsulated pebble comprises a ceramic shell. The ceramic shell may be a layer intermediate the fuel core and the cage. In some embodiments, the ceramic shell encloses the fuel core. In some embodiments, the ceramic shell is disposed on and in direct contact with the fuel core.

In some embodiments, the encapsulated pebble comprises a ceramic insert disposed within the at least one gas transport channel. In some embodiments, the encapsulated pebble comprises a plurality of gas transport channels, each with a ceramic insert disposed therein.

In some embodiments, the ceramic is porous, for example gas-permeable, thereby allowing transport of gas (tritium, helium) from the fuel core out of the pebble to the rest of the breeding blanket. In some embodiments, the ceramic is gas-permeable, but impermeable to liquid, thus enabling confinement of a molten salt within the fuel core.

In some embodiments, the ceramic is gas-permeable, meaning that it has a pore size that will permit permeation of tritium and/or helium from the core, through a ceramic shell to a void between the cage and the ceramic shell, or through a ceramic insert disposed in a channel in the cage, from where the gas can be transported through the cage. The pore size required for allowing gas permeation while preventing leakage of liquid tritium breeding material will depend on the operating temperature in the breeding blanket, and thus the pressure difference across the porous ceramic. Typically, the pore size will be less than 1 μm, for example less than 0.5 μm, for example less than 0.25 μm, for example less than 0.1 μm. Methods of controlling pore size or ceramics are known in the art, for example by the inclusion of sacrificial template materials and controlling sintering time and/or sintering temperature.

The ceramic may comprise a material selected for its inertness to a molten salt of the fuel core. The ceramic may comprise a material selected for its ability to withstand operating temperatures within a breeding blanket, where temperatures can easily reach in excess of 300° C. and can be in excess of 900° C. For example, the ceramic may comprise a material selected from silica, porous graphite, silicon carbide, zinc carbide, titanium carbide and mixtures thereof.

In these embodiments, the ceramic protects the rest of the breeder blanket from the corrosive nature of the molten core during operation but also protects the cage from the internal temperatures of the fuel core during operation, as cyclic thermal operations up to these temperatures can stress the metals and negatively impact on the usable lifetime of the cage through deformation and fatigue. The porous or gas-permeable nature of the ceramic also allows permeation of gaseous tritium and helium from the core to prevent internal pressure building up, while preventing escape of molten fuel. When present, the ceramic is protected from physical erosion or abrasion by the metallic cage.

In some embodiments, a gas pocket is provided in the encapsulated pebble. In some embodiments, the gas pocket is provided within a ceramic shell disposed within the cage. In some embodiments, the cage is provided with ceramic inserts and the gas pocket is provided within the cage. In some examples, the gas pocket comprises a coolant gas, which may the same coolant gas as is used in the breeding blanket, or it may be a different coolant gas. In some examples, the coolant gas comprises nitrogen gas, helium gas, krypton gas, xenon gas. Providing a volume of coolant gas within the encapsulated fuel pebble allows for pressure changes within the fuel core to be accommodated, and provides a location within the pebble to which helium and molecular tritium can desorb or degas prior to permeating from the fuel core.

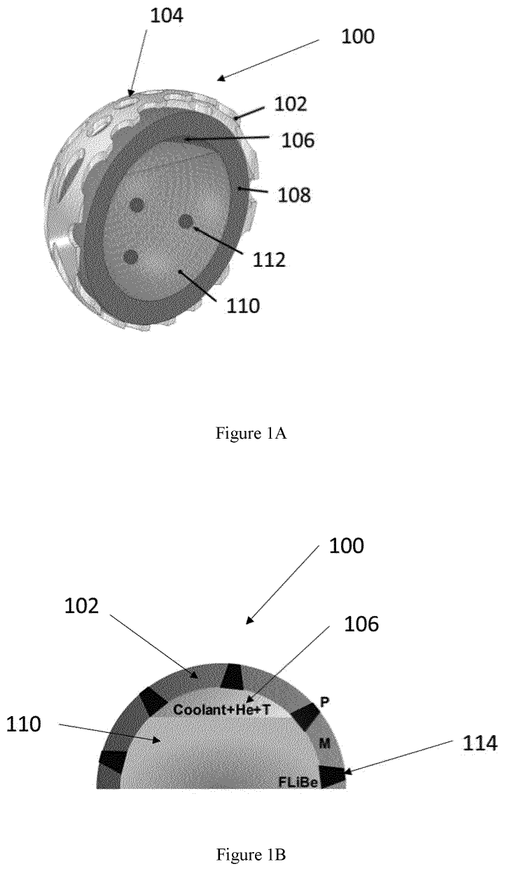

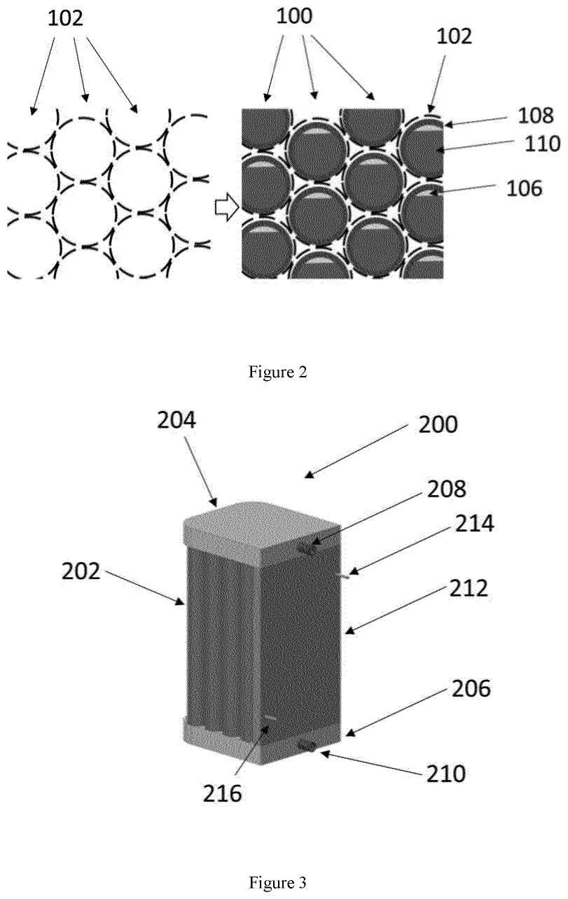

Examples of encapsulated pebbles are provided in FIGS. 1A and 1B. The examples show particular embodiments, such as for example the use of a metallic cage, but it will be understood that these are by way of example only and other configurations and materials are possible. FIG. 1A shows the structure of an encapsulated pebble 100 comprising a metallic cage 102 as the outermost shell, a ceramic shell 108 within metallic cage 102 and a fuel core 110 within ceramic shell 108. Metallic cage 102 is provided with a plurality of holes or gas transport channels 104 that allow flow of gas in both directions. As described above, gas transport channels 104 permit flow of helium and tritium generated within fuel core 110 to exit encapsulated fuel pebble 100. Although not depicted clearly in FIG. 1A (but shown in FIG. 2 which is described below), the internal radius of metallic cage 102 is larger than the external radius of ceramic shell 108, thereby providing clearance between metallic cage 102 and ceramic shell 108. This clearance means that coolant gas can enter into the space between metallic cage 102 and ceramic shell 108 and directly cool ceramic shell 108, increasing the efficiency of the cooling process. Within ceramic shell 108, a fuel core 110 is provided. Fuel core 110 may comprise a lithium salt, such as FLiBe described above. Neutrons escaping the plasma from the fusion reactor react with the lithium, breeding the tritium. A pocket of coolant gas 106 is provided within ceramic shell 108, to which molecular tritium and helium can desorb from fuel core 110 prior to permeating through porous ceramic shell 108 and exiting encapsulated fuel pebble 100 via gas transport channels 104. In order to control the redox reactions within fuel core 110 and minimize the amount of corrosive tritium fluoride produced, seeds of redox material 112 such as metallic beryllium have also been included in fuel core 110.

FIG. 1B shows the structure of an alternative encapsulated pebble 100. Pebble 100 of FIG. 1B has the same metallic cage 102 as pebble 100 of FIG. 1A, but has ceramic inserts 114 in place of ceramic shell 108. Ceramic inserts 114 are inserted into the gas transport channels (not numbered) of metallic cage 102, thereby providing a gas-permeable but molten salt-impermeable path for tritium and helium to exit encapsulated pebble 100. As with the pebble of FIG. 1A, gas pocket 106 is provided, this time within metallic cage 102, initially filled with coolant gas but to which tritium and helium can desorb during operation. Although not shown, seeds of redox material would also be included within fuel core 110, to prevent formation of corrosive materials that would otherwise degrade metallic cage 102.

FIG. 2 shows schematics of a plurality of encapsulated pebbles packed together, for example as when present in a pebble bed of a breeding blanket module as described herein. The left hand part of FIG. 2 demonstrates one example in which metallic cages 102 (in the absence of any internal components of the encapsulated pebble) can be packed together. Each metallic cage 102 is provided with a plurality of gas transport channels, in fluid communication with the voids between the metallic cages 102 and with gas transport channels of other metallic cages 102. Thus, when present in a pebble bed, the body of metallic cages 102 provide a mesh network through which coolant gas can flow. The right-hand part of FIG. 2A shows a packed bed of encapsulated pebbles 100 based on the same packing of metallic cages 102 as shown in the left-hand part of the Figure. As can be seen, the external dimensions of ceramic shells 108 are less than the internal dimensions of metallic cages 102, thus providing a flow path for coolant gas between the two. To complete the encapsulated pebble, ceramic shells 108 are provided with fuel core 110 and gas pocket 106, as described above.

### Method of Forming an Encapsulated Pebble

Also described herein is a method of forming an encapsulated pebble, comprising: encapsulating a fuel core within a cage, wherein the cage comprises at least one gas transport channel therethrough. The encapsulated pebble may be as described above.

Various methods of forming the various components of an encapsulated pebble are possible, as will be appreciated by those skilled in the art.

For example, methods of forming small, hollow, metallic spheres on sacrificial supports such as polystyrene are known (https://www.hollomet.com/en/home.html), in which the support is held in a fluidized bed and a suspension of metal powder with binder (for example water) is sprayed onto the surface of the support in a spray deposition method. Heat treatment can burn off the sacrificial support and binder, leaving the green body of a hollow metal sphere which can then be sintered under controlled conditions to form the metallic cage with defined porosity. Laser drilling can then form an opening in the cage through which a fuel can be inserted, following by welding to seal the opening. The at least one gas transport channel through the metallic cage can be formed by laser drilling, for example. Laser drilling techniques are capable of accurately providing holes down to 0.5 μm in diameter, for example.

In an alternative process, metallic hemispheres may be formed over sacrificial supports as above. After the sacrificial support and organic binder have been burned off, and the metallic hemispheres sintered, a fuel core can be arranged in a first hemisphere, which will form a first part of the metallic cage, and a second part of the metallic cage in the form of a second hemisphere can be joined to the first hemisphere so as to encapsulate the fuel core. The two hemispheres can be joined by welding, for example, so as to encapsulate the fuel core.

Hollow ceramic spheres or hemispheres can also be formed on sacrificial supports as described above (https://www.hollomet.com/en/home.html). In the embodiment in which a gas pocket is provided within a ceramic shell, a sacrificial support of the same dimensions as the gas pocket can be used in combination with a molded fuel core as the template for ceramic deposition, with the sacrificial support being later burned off. The ceramic green bodies can then be sintered under controlled conditions to produce the ceramic shell having a defined porosity. Control of pore size in ceramics is known in the art: see, for example Isobe et al., Pore size control of Al₂O₃ ceramics using two-step sintering, Ceramics International (2012), Vol 38(1), 787-793 which describes controlling pore size formation to provide average pore sizes as low as 22 nm, and methods of determining pore size. In one embodiment, the ceramic shell is formed around the fuel core by forming two ceramic hemispheres, arranging a fuel core in one of the ceramic hemispheres and joining the two hemispheres together to encapsulate the fuel core. The two hemispheres may be joined by providing a band, for example a metallic band around the two hemispheres and clamping together the two hemispheres.

### Breeding Blanket Module for a Fusion Reactor

Also described herein is a breeding blanket module for a fusion reactor, comprising: a plurality of pebble beds connected in series and/or in parallel; and a plurality of encapsulated pebbles within each pebble bed. At least one, but in some examples all, of the plurality of encapsulated pebbles are pebbles as described herein. In some examples, the pebble beds may be referred to as fuel beds as the tritium fuel for the reactor is generated within the beds.

The pebble beds may be arranged parallel to one another in an array of beds. In some examples, each pebble bed of the plurality of pebble beds is in fluid communication with a gas inlet and a gas outlet via a gas inlet manifold and a gas outlet manifold respectively. The gas inlet manifold may be connected to a source of coolant gas, for example a source of nitrogen gas, helium gas or krypton gas. The flow of coolant gas through the pebble beds serves two purposes, namely to provide cooling to the encapsulated pebbles and also to extract the generated tritium. The gas outlet manifold may be configured to recycle the tritium into the plasma of a fusion reactor as fuel.

In some examples, one or both of the gas inlet manifold and gas outlet manifold is provided with a plenum, configured to receive and allow accumulation of any breeder material that leaks from the encapsulated fuel pebbles to avoid any impact on the performance of the breeding unit.

In some embodiments, each pebble bed is an elongate bed. Each bed may be cylindrical, which enables efficient packing of encapsulated pebbles. However, other configurations are envisaged. In one embodiment, the pebble bed comprises a honeycomb structure in which each bed shares at least one wall with an adjacent bed. Regardless of the geometrical shape of the beds, each bed may have a first end and a second end, and in one embodiment the gas inlet manifold is configured to engage with the first end and the gas outlet manifold is configured to engage with the second end so that the plurality of beds are connected in parallel.

In some embodiments, the gas inlet manifold and gas outlet manifold are configured to define one or more flow paths through the plurality of beds. For example, each bed of the plurality of beds is provided in one of at least two groups of beds, which may be defined based on the flow path defined by the manifold configurations. A first group of the at least two groups may define a first gas flow path from the gas inlet through at least one bed of the first group to the gas outlet, and a second group of the at least two groups defines a second gas flow path from the gas inlet through at least one bed of the second group to the gas outlet. The first gas flow path and second gas flow path may be connected in parallel from the gas inlet to the gas outlet, although it will be understood that at any moment of operation, gas flow in one bed may be flowing counter current to the gas flow in an adjacent or non-adjacent bed. However, within each group of beds, each bed is connected in series with at least one other bed. That is, coolant gas flows out of, for example, the bottom or first end of one bed and back into the bottom or second end of the next bed. The number of groups of beds can be selected based on the total number of beds and the optimal flow path or flow paths of coolant gas to provide the required cooling to the encapsulated pebbles. In one embodiment, the manifolds are configured to direct coolant gas on one or more flow paths that begin with the beds closest to the plasma, to provide maximum cooling to those beds that need it most, before continuing to the beds spaced from the front (plasma side) of the breeding blanket module.

The plurality of fuel beds may be elongate beds, each having one or more walls to define an internal volume to receive the encapsulated pebbles. The wall or walls of the beds may be formed from any material suitable for use in a breeding blanket for a fusion reactor, for example a reduced activation ferritic martensitic steel such as described above in connection with the cage of the encapsulated pebble.

In some embodiments, and to maximise tritium extraction processes, the plurality of beds are provided with a tritium permeation barrier coating, for example a coating of chromia (Cr₂O₃) or alumina (Al₂O₃). This ensures that tritium flows from the beds through the gas outlet manifold at which point it can be extracted and sent to the reactor plasma.

In some embodiments, the plurality of beds are spaced from one another with voids provided therebetween. A neutron multiplier material, for example lead sulfide, can be provided in the voids between adjacent beds. Neutron multiplier materials in breeding blankets are known, and can be used to enhance the tritium breeding ratio of the breeding material. It will therefore be understood that other neutron multiplier materials may be used, for example Zr₅Pb₄, pure beryllium or Be₁₂Ti. In some embodiments, the neutron multiplier material is provided in the form of a plurality of pebbles in a pebble bed, or a bed of compressed powder, between the coolant pipes or beds.

In some embodiments, a neutron reflector panel is provided in the breeding blanket module. The neutron reflector panel may be provided at the back of the breeding beds, so that, in use, the beds are disposed between the reflector panel and a first wall. The use of a reflector panel may improve the neutron economy of the blanket and also generate more tritium, meaning that the total thickness of the blanket module can be reduced. In some embodiments, the neutron reflector panel comprises or is formed from a neutron reflector material, for example tungsten carbide or tungsten boride. In some embodiments, the neutron reflector panel comprises a steel casing, for example a EUROFER 97 steel casing, which is filled with a neutron reflector material, for example tungsten carbide or tungsten boride. In some embodiments, the neutron reflector panel is provided with cooling. In some embodiments, the neutron reflector panel is provided with an inlet and an outlet for supply of a coolant, for example a coolant gas such as those described herein or a liquid refrigerant.

In some embodiments, at least two of the encapsulated pebbles within the plurality of fuel beds comprise fuel cores that are the same compositions. In other embodiments, at least two of the encapsulated pebbles comprise cores that are different compositions. For example, in one embodiment at least two of the encapsulated pebbles comprise a Li₂·BeF₄ core, while in another embodiment at least one of the encapsulated fuel pebbles comprises a Li₂·BeF₄ and at least one of the encapsulated fuel pebbles comprises a core different to Li₂·BeF₄.

In some embodiments, the breeding blanket module is configured to engage with a first wall component of a fusion reactor. In some embodiments, the fusion reactor is a tokamak, for example a spherical tokamak. In some embodiments, the spherical tokamak may be a compact spherical tokamak. In some embodiments, the breeding blanket module is arranged such that, in use, in a fusion reactor such as a spherical tokamak, the fuel beds are oriented poloidally. In some embodiments, the plurality of fuel beds are arranged in an array, with a first row or bank of fuel beds being arranged adjacent to a first wall component of the fusion reactor with further rows or banks of fuel beds being arranged behind the first row or bank of fuel beds.

An example of a breeding blanket module is shown in FIG. 3. Breeding blanket module 200 comprises a plurality of pebble beds 202 in the form of a plurality of elongate, cylindrical units. Each pebble bed, which may also be referred to as a breeding unit, is provided with a plurality of encapsulated fel pebbles, for example such as those described herein. However, it will be appreciated that other pebbles capable of breeding tritium in a fusion process could be used. Pebble beds 202 are joined and capped at their ends, by manifolds 204 and 206. Manifolds 204 and 206 and provided with gas inlet 208 and gas outlet 210 respectively, though it is noted that the direction of gas flow is arbitrary and could be reversed meaning that feature 210 could be used as a gas inlet and feature 208 could be used as a gas outlet. Reflector panel 212, comprising neutron reflecting material, is provided at the back end (in use) of breeding blanket module 200, and is provided with separate connectors 214 and 216 for coolant flow. It will be understood that other components of breeding blanket module 200, such as supports, and means for attaching it to other components of the reactor are not shown. In particular, breeding blanket module 200 may be provided with an outer casing or wall, to allow back-filling of a bed of neutron multiplier material between adjacent beds 202, and between beds 202 and the outer casing or wall. Breeding blanket module 200 may be configured to join, interact or engage with a first wall component of the fusion reactor.

### Method of Operating the Breeding Blanket Module and Uses

Also described herein is a method of operating a breeding blanket module as described, comprising: providing a flow of coolant gas to the breeding blanket module: allowing the coolant gas to extract heat and tritium from the breed blanket module providing a warmed gas enriched with tritium; removing the warmed gas from the breeding blanket module; and extracting the tritium from the warmed gas. The breeding blanket module maybe present in a fusion reactor and may be heated by the reactor. The coolant gas may comprise one or more coolant gas selected from nitrogen, helium, and carbon dioxide.

There is also described a fusion reactor comprising an encapsulated pebble and/or a breeding blanket module as described herein, along with the use of an encapsulated pebble as described herein in a fusion reactor or a fission reactor, and a use of a breeding blanket module as described herein in a fusion reactor. The fusion reactor may be a tokamak reactor, for example a spherical tokamak reactor.

Modelling studies of the encapsulated pebbles, and of the breeding blanket module containing the encapsulated pebbles, demonstrate the feasibility and workability of the pebbles and breeding blanket in fusion reactors.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1-50. (canceled)

51. An encapsulated pebble, comprising:
a fuel core; and
a cage encapsulating the fuel core, wherein the cage comprises at least one gas transport channel therethrough.

52. The encapsulated pebble of claim 51, wherein the cage comprises a plurality of gas transport channels.

53. The encapsulated pebble of claim 51, further comprising:
a ceramic shell contained within the cage and surrounding the fuel core; and/or
a ceramic insert provided in the at least one gas transport channel.

54. The encapsulated pebble of claim 53, wherein the ceramic shell and/or the ceramic insert comprises a gas-permeable ceramic comprising a gas-permeable silica, a gas-permeable graphite, or a gas-permeable silicon carbide.

55. The encapsulated pebble of claim 54, wherein the gas-permeable ceramic comprises a porous ceramic having a pore radius of less than 0.25 μm.

56. The encapsulated pebble of claim 51, wherein the internal diameter of the cage is larger than the external diameter of the fuel core and/or wherein the internal diameter of the cage is larger than the external diameter of the ceramic shell.

57. The encapsulated pebble of claim 51, wherein the fuel core comprises a breeding material, optionally wherein the breeding material comprises a breeding material capable of generating tritium.

58. The encapsulated pebble of claim 51, wherein the fuel core comprises a molten salt that is liquid above the operating temperature of a nuclear reactor comprising a temperature of about 300° C.

59. The encapsulated pebble according to claim 51, wherein the fuel core comprises a lithium salt, optionally wherein the lithium salt comprises Li₂·BeF₄.

60. The encapsulated pebble of claim 51, wherein the fuel core further comprises a redox controlling material, optionally wherein the redox controlling material comprises metallic beryllium.

61. The encapsulated pebble of claim 51, wherein a gas pocket is provided in the encapsulated fuel pebble.

62. The encapsulated pebble of claim 61, wherein a ceramic shell is contained within the cage and the gas pocket is provided within the ceramic shell.

63. The encapsulated pebble of claim 61, wherein a coolant gas is provided in the gas pocket, optionally wherein the coolant gas comprises nitrogen gas or helium gas.

64. The encapsulated pebble of claim 51, wherein the cage is a metallic cage, optionally wherein the metallic cage comprises a metallic alloy.

65. The encapsulated pebble of claim 64, wherein the metallic alloy comprises a reduced activation ferritic martensitic steel.

66. A method of forming an encapsulated pebble, comprising:
encapsulating a fuel core within a cage, wherein the cage comprises at least one gas transport channel therethrough.

67. The method of claim 66, comprising:
arranging a fuel core in a first part of a cage; and
joining a second part of a cage to the first part so as to encapsulate the fuel core; or
forming a cage;
forming an opening in the cage;
inserting a fuel through the opening so as to form a fuel core within the cage; and
sealing the opening so as to encapsulate the fuel core; or
forming a ceramic shell around the fuel core; and
encapsulating the formed ceramic shell within the cage.

68. The method of claim 66, comprising:
forming at least one gas transport channel through the cage, optionally wherein the at least one gas transport channel comprises a plurality of gas transport channels.

69. The method of claim 68, wherein forming at least one gas transport channel comprises laser drilling the cage to form the at least one gas transport channel; or wherein forming at least one gas transport channel comprises controlling porosity of the cage during a sintering process of forming the cage.

70. A breeding blanket module for a fusion reactor, comprising:
a plurality of pebble beds connected in series and/or in parallel; and
a plurality of encapsulated pebbles within each pebble bed.
